(19) United States
(12) Patent Application Publication
(10) Pub. No.: US 2011/0134032 A1
(43) Pub. Date: Jun. 9, 2011

(54) METHOD FOR CONTROLLING TOUCH CONTROL MODULE AND ELECTRONIC DEVICE THEREOF

(76) Inventors: Kuo-Chung CHIU, Taipei (TW); Wei-Wen Luo, Taipei (TW); Wen-Chieh Tseng, Taipei (TW); Sheng-Kai Tang, Taipei (TW)

(21) Appl. No.: 12/963,216

(22) Filed: Dec. 8, 2010

(30) Foreign Application Priority Data
Dec. 9, 2009 (CN) 200910250441.6

(51) Int. Cl. G06F 3/033; G06F 3/041; G06F 3/044

(52) U.S. Cl. 345/157; 345/173; 345/174

(57) ABSTRACT

A method for controlling a touch control module and an electronic device are provides. The electronic device includes a display and a host. The host includes a sensing module, a touch control module and a control unit. The sensing module includes a sensing unit for detecting the gesture and generating the corresponding sensing signal. The control unit determines whether the gesture complies with a preset condition according to the sensing signal. When the determining result is yes, the control unit controls the touch control module to enter the first control mode. On the contrary, if the determining result is no, the control unit controls the touch control module to enter the second control mode.

### CROSS REFERENCE TO RELATED APPLICATIONS

This Non-provisional application claims priority under 35 U.S.C. §119(a) on Patent Application No(s). 200910250441.6 filed in People's Republic of China on Dec. 9, 2009, the entire contents of which are hereby incorporated by reference.

### BACKGROUND OF THE INVENTION

1. Field of Invention

The invention relates to a method for controlling a touch control module, and more particularly, to a method for controlling a touch control module to switch the control modes automatically.

2. Related Art

A graphical user interface (GUI) is an operating interface by most computers. The GUI allows users to select and perform functions by controlling a cursor on an icon that showed on the display. Users mainly control the position of the cursor by a mouse for a desktop computer, and, that by the mouse or touch pads for notebook computers.

Besides, to make it easier in operating the commonly-used commands, the manufacturers usually set several hotkeys on the input equipment that corresponds to the commonly-used commands. Thus, the user may execute the specific commands such as controlling the volume of a loud speaker, adjusting the display luminance and displaying music by pressing the hotkeys directly without controlling the cursor to click and execute the specific software. In the notebook computer, besides hotkeys setup on the keyboard, the user also may set the hotkeys based on the functions and executed accordingly via the touch pad.

FIG. 1 is a schematic diagram showing a conventional notebook computer 8. As shown in FIG. 1, the conventional notebook computer 8 includes a display 80 and a host 82. The host 82 includes a keyboard 84 and a touch pad 86. The touch pad 86 includes a first control mode and a second control mode, the touch pad 86 also defines multiple operation areas 86n, and each operation area 86n corresponds to a preset function.

The control mode of the touch pad 86 on the notebook computer 8 can be switched via the hotkey on the keyboard 84. For example, the user may switch the mode of the touch pad 86 between the first control mode and the second control mode by pressing the functional key and the space key at the same time. When the touch pad 86 operates in the first control mode, the user may control the cursor on the display 80 via the touch pad 86 to click the icon and execute a program. When the touch pad operates in the second control mode, the user may click different operation areas 86n on the touch pad 86 to perform the corresponding preset functions.

The way for switching the control mode makes the touch pad 86 more input functions. However, users have to move their hands between the keyboard 84 and the touch pad 86 repeatedly, thus cause inconvenient, and the user's hand may get fatigue.

FIG. 2 is a partial schematic diagram showing a host 90 of another conventional notebook computer 9. As shown in FIG. 2, the host 90 of the notebook computer 9 equips a keyboard 92 and a touch pad 94. The touch pad 94 includes a first control mode and a second control mode. Further, a mode switching area 94a and a functional operating area 94b are defined on the touch pad 94. Besides, the functional operating area 94b may be further divided into several sub-operation areas, and each sub-operation area may correspond to at least a preset function.

The mode switching area 94a can be used to switch the modes of the touch pad 94a between the first control mode and the second control mode. When the touch pad 94 operates in the first control mode, the user may control the cursor on the display to move, click and execute the program via the touch pad 94. Moreover, when the touch pad 94 is switched to the second control mode, hotkeys are provided on the touch pad 94 and allow to be selected the sub-operation areas of the functional operating area 94b to execute the corresponding preset functions.

It is more convenient for users to switch the control mode via the touch pad 94 without moving their hands between the keyboard 92 and the touch pad 94 in the above description. However, when the user needs to control the cursor on the display via the touch pad under the first control mode, his fingers may touch the mode switching area 94a accidentally, and the first control mode of the touch pad 94 may be switched to the second control mode unintentionally. Moreover, users' palms may also touch the mode switching area 94a accidentally when the user inputs information via the keyboard 92, and the control mode of the touch pad 86 may also be switched unintentionally. Therefore, the user may not know the current control mode, and the trouble in operation is generated.

### SUMMARY OF THE INVENTION

A method for controlling a touch control module of an electronic device is disclosed.

According to an embodiment, the method is adapted to an electronic device. The electronic device includes a display and a sensing module. The method includes the steps as follows, the sensing unit detects the gesture and generates a corresponding sensing signal; whether the gesture complies with a preset condition is determined according to the sensing signal; if the gesture complies with the preset condition, the touch control module enters a first control mode, and if the gesture does not comply with the preset condition, the touch control module enters a second control mode.

An electronic device is also disclosed in another embodiment.

According to an embodiment, the electronic device includes a display and a host connected to the display. Furthermore, the host includes a sensing module, a touch control module and a control unit. The sensing module includes a sensing unit for detecting the gesture and generating the corresponding sensing signal. The control unit is electrically connected to the touch control module and the sensing module for determining whether the gesture complies with the preset condition according to the sensing signal sensed by the sensing unit. If the determining result is yes, the touch control module enters the first control mode, and if the determining result is no, the touch control module enters the second control mode.

To sum up, according to the method for controlling the touch control module and the electronic device in the invention, the gesture may be detected during operating the touch control module, and the control mode of the touch control module is switched automatically. Therefore, the control mode of the touch control module does NOT need to be switched manually, and it also may not be switched by mistake. Therefore, the control mode of the touch control module will be varied and more convenient for users.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional notebook computer.

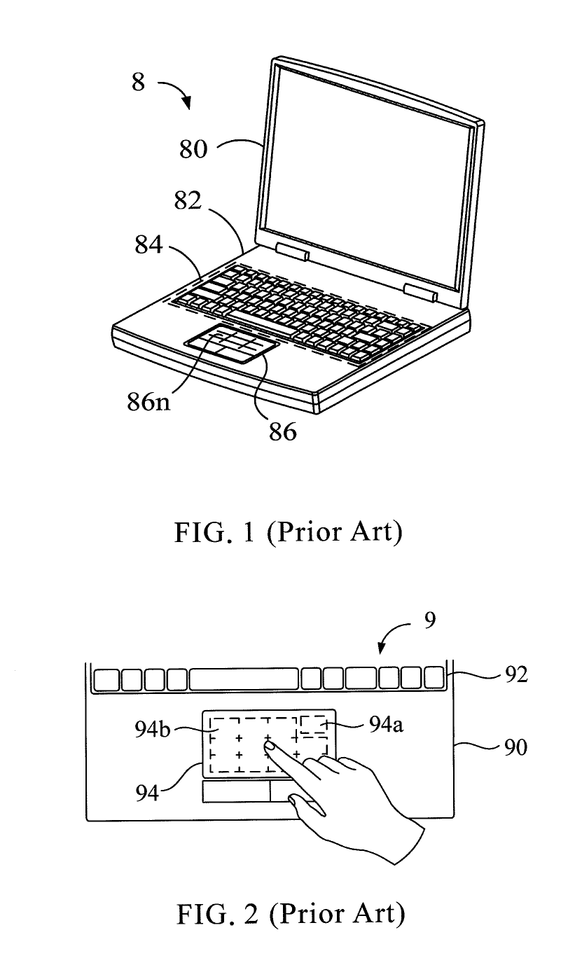

FIG. 2 is a partial schematic diagram showing a conventional touch pad.

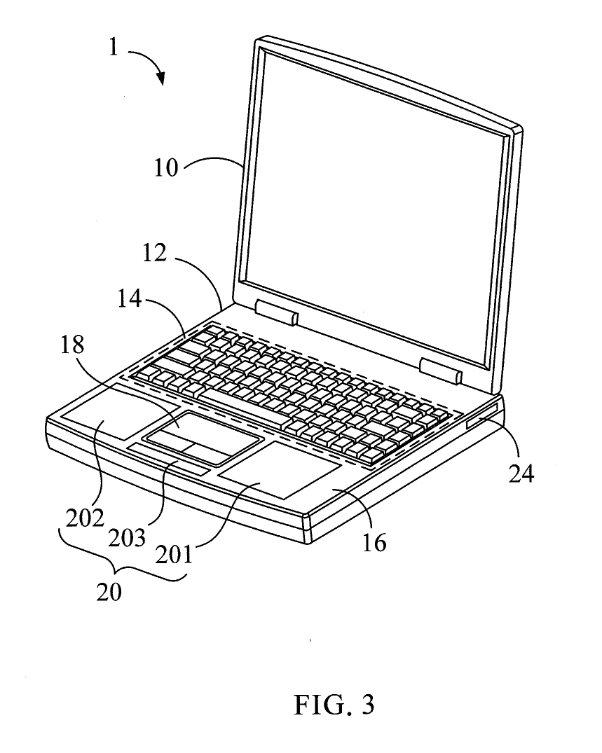

FIG. 3 is a schematic diagram showing the electronic device in an embodiment.

FIG. 4 is a functional block diagram showing the electronic device in an embodiment.

FIG. 5A and FIG. 5B are schematic diagrams showing that the user uses the touch control module to control the cursor in an embodiment.

FIG. 6A to FIG. 6D are schematic diagrams showing that the user performs the preset function via the touch control module in an embodiment.

FIG. 7 is a flow chart diagram showing the method for controlling the touch control module in an embodiment.

FIG. 8 is a flow chart showing the method of the first control mode of the touch control module in an embodiment.

### DETAILED DESCRIPTION OF THE INVENTION

An electronic device and a method for controlling a touch control module are provided for switching control modes of the touch control module automatically. The embodiments of the electronic device and the method for controlling the touch control module are shown hereinbelow.

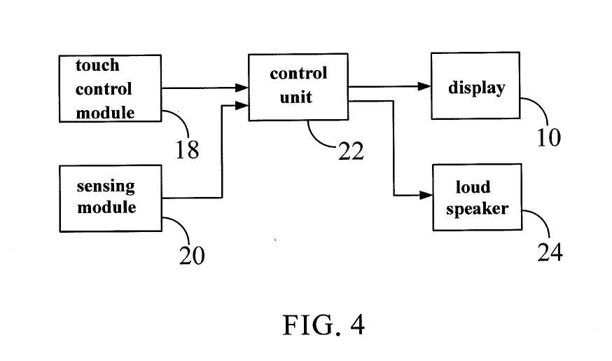

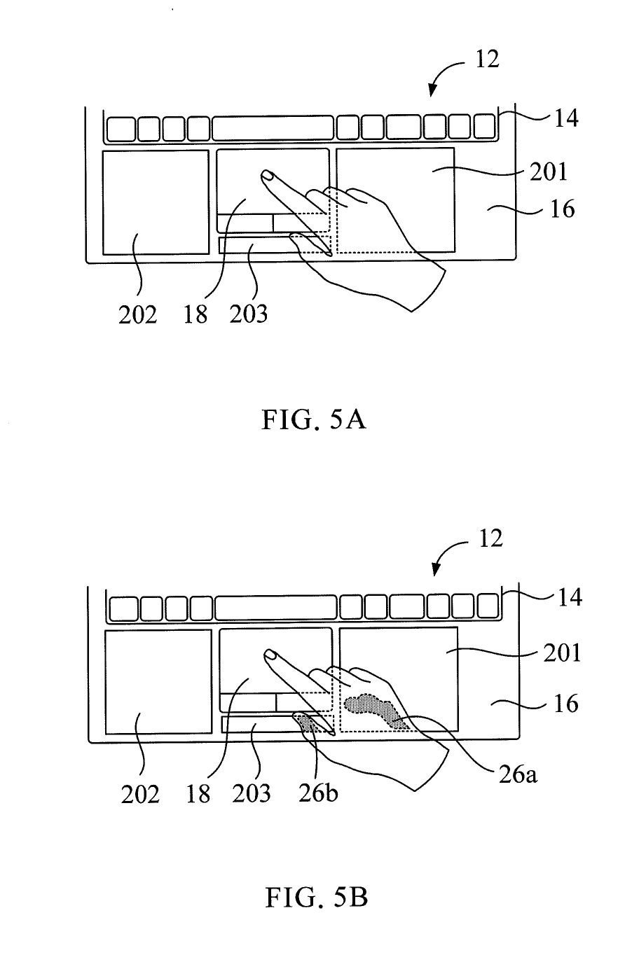

FIG. 3 is a schematic diagram showing the electronic device in an embodiment. FIG. 4 is a functional block diagram showing the electronic device in the embodiment.

As shown in FIG. 3 and FIG. 4, the electronic device 1 in the embodiment includes a display 10 and a host 12 connected to the display 10. The host 12 includes a keyboard 14, a palm rest board 16, a touch control module 18, a sensing module 20, a control unit 22 and a speaker 24. The keyboard 14 is disposed at the upper part of the host 12, and the palm rest board 16 is disposed at the lower part of the host 12. The touch control module 18 is disposed on the palm rest board 16 and near the middle of the palm rest board 16. In practical usage, the size and the position of the touch control module 18 are adjustable according to the requirement, and it is not limited to the embodiment.

The sensing module 20 includes at least a sensing unit. The sensing unit is disposed on the palm rest board 16 and near the touch pad 18 for detecting the hand gesture of a user. The hand gesture is a finger gesture, a palm gesture or their combination. The sensing module 20 then generates a corresponding sensing signal to the control unit 22 according to the detecting result.

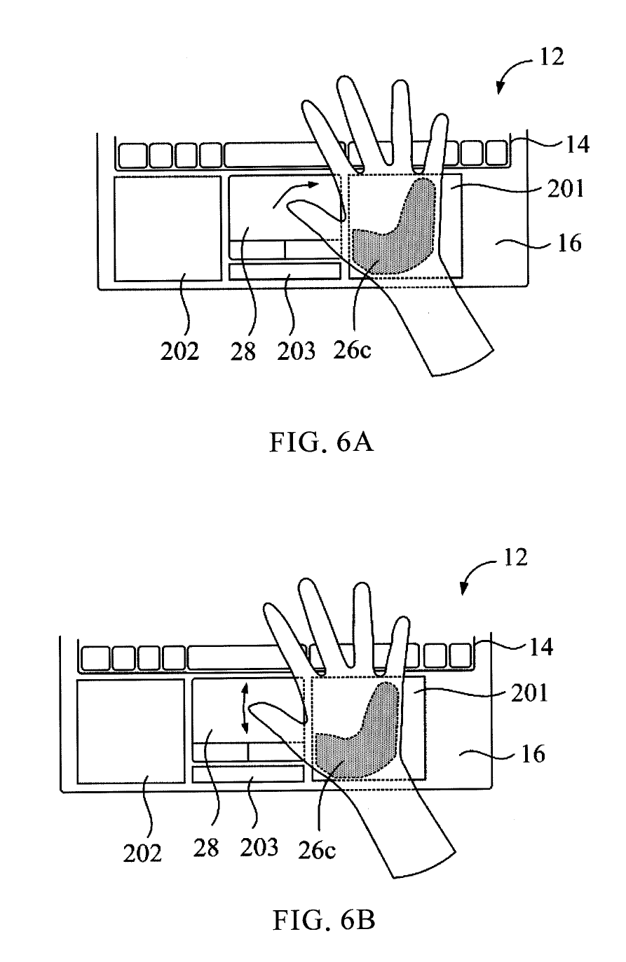

To detect the user's gesture more precisely, the sensing module 20 usually includes multiple sensing units. For example, in the embodiment, the sensing module 20 includes a first sensing unit 201, a second sensing unit 202 and a third sensing unit 203 disposed near the touch control module 18 (for example, in the embodiment as shown in FIG. 5B, the first sensing unit 201, the second sensing unit 202 and the third sensing unit 203 are disposed at the left side, the right side and the lower part of the touch control module 18, respectively.) to detect gesture whether the hands are contact to the palm rest board 16. In practical usage, the sensing unit may be a capacitance sensor, a proximity sensor or a luminance sensor.

The control unit 22 is disposed in the host 12, and is electrically connected to the touch control module 18 and the sensing module 20. The control unit 22 first receives the sensing signals generated by the sensing units to determine whether the gesture complies with a preset condition. For example, the preset condition may be defined as the hand position in which the user performs the preset function via the touch control module 18. Therefore, if the control unit 22 determines that the position of the gesture does not comply with the preset condition, it is determined that the user is controlling the position of the cursor on the display by the touch control module 18. Thus, the control unit 22 then controls the touch control module 18 to enter the second control mode to allow the user to control the cursor displayed on the display 10 via the touch control module 18.

In the embodiment, if the control unit 22 determines that the position of the gesture complies with the preset condition according to the sensing signal, the control unit 22 further determines whether the shape of the hand gesture complies with a preset shape according to the sensing signal. If the determining result is yes, the control unit 22 controls the touch control module 18 to enter the first control mode for the users to perform the preset function via the touch control module 18 of the electronic device 1. If the determining result is no, the control unit 22 then controls the touch control module 18 to enter the second control mode. In other embodiments, if the control unit 22 determines that the gesture complies with the preset condition according to the sensing signal, it may directly control the touch control module 18 to enter the first control mode for users to control the electronic device 1 to perform the preset function via the touch control module 18. The preset function may be varied such as to adjust the contrast, the pixel size, the media functions, the luminance adjustment, the color saturation adjustment, the color temperature adjustment, the display rotation adjustment, closing the display, the volume adjustment, the mute, the sound field adjustment and the track adjustment, but it is not limited herein.

The embodiments are illustrated hereinbelow with regard to the drawings. FIG. 5A and FIG. 5B are schematic diagrams showing that the user uses the touch control module 18 to control the cursor on the display in an embodiment. As shown in FIG. 5A, the user's palm is totally suspended above the palm rest board 16, and the first sensing unit 201, the second sensing unit 202 and the third sensing unit 203 may detect the gesture to generate a corresponding sensing signal to the control unit 22. The control unit 22 determines that the gesture does not comply with the preset condition according to the sensing signal. For example, if the user's palm is not contacting the palm rest board 16, the control unit 22 will then control the touch control module 18 to enter the second control mode for the users to control the cursor displayed on the display 10 via the touch control module 18.

As shown in FIG. 5B, when the user's right palm is disposed on the palm rest board 16, the user's right palm contacts the first sensing unit 201 and the third sensing unit 203 and generates a first contacting area 26a and a second contacting area 26b, respectively. At that moment, the first sensing unit 201 and the third sensing unit 203 may detect the gesture including the contact area and other information, and generate the corresponding sensing signal to the control unit 22. In detail, the first sensing unit 201 and the third sensing unit 203 detect the sizes, the shapes and the positions of the first contacting area 26a and the second contacting area 26b and generate the sensing signal including the information about the first contacting area 26a and the second contacting area 26b. In practical usage, the sensing units 20 may be arranged according to a proper density and arranging modes and disposed on the palm rest board 16 of the electronic device 1 to provide the related information more precisely. The arranging mode may be varied, and in an embodiment, the arranging mode is an array.

After the control unit 22 receives the sensing signal, whether the gesture complies with the preset condition according to the sensing signal is determined. For example, it is determined that the user's hand is disposed on the palm rest board 16. Then, the control unit 22 determines that the shape of the gesture does not comply with the preset shape according to the information included in the sensing signal such as the sizes, the shapes and positions of the first contacting area 26a and the second contacting area 26b. That is, the gesture is not compliant to that for executing the preset function in the second control mode in the touch control module. Then, the control unit 22 controls the touch control module 18 to enter the second control mode for the user to control the cursor displayed on the display 10 via the touch control module 18.

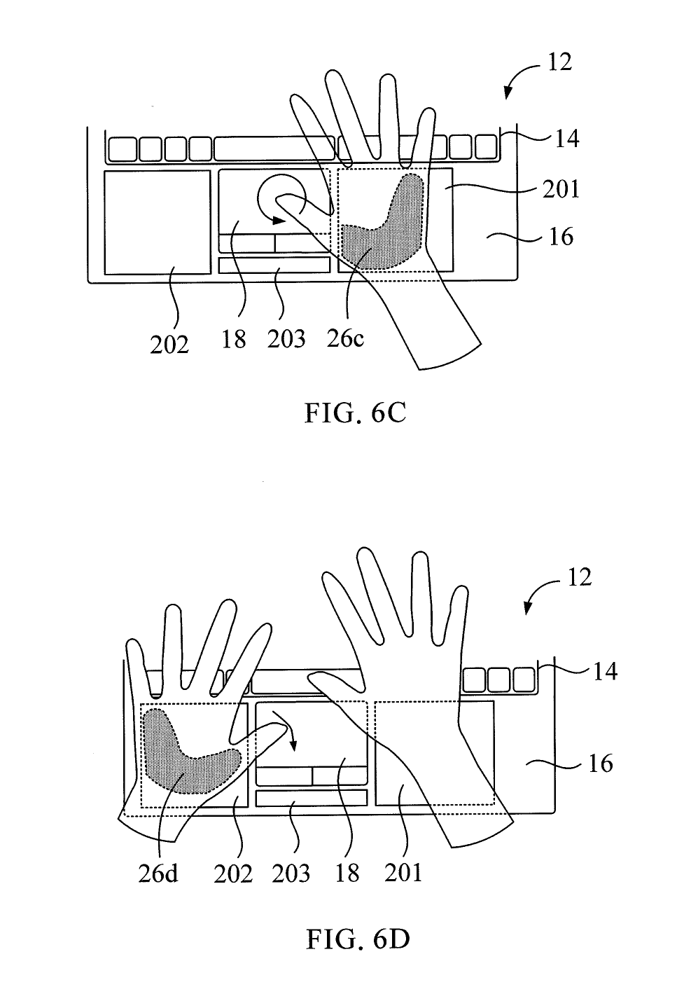

FIG. 6A to FIG. 6D are schematic diagrams showing that how users perform the preset function via the touch control module 18 in an embodiment. As shown in FIG. 6A to FIG. 6C, the user's right palm is disposed on the palm rest board 16, and it contacts the first sensing unit 201 to generate a third contacting area 26c. At that moment, the first sensing unit 201 generates and transmits the corresponding sensing signal to the control unit 22 according to the detected hand gesture when the right palm is disposed on the palm rest board 16. The hand gesture includes the size, the shape and the position of the third contacting area 26c. As shown in FIG. 6D, the user's left palm is disposed on the palm rest board 16, and it contacts the second sensing unit 202 to generate a fourth contacting area 26d. Similarly, the second sensing unit 202 also may generate the corresponding sensing signal according to the detected hand gesture when the user's left palm is disposed on the palm rest board 16.

After the control unit 22 receives the sensing signal, it first determines whether the gesture complies with the preset condition. For example, whether the user's hand is disposed on the palm rest board 16 is determined, but it is not limited thereto. Then, the control unit 22 determines whether the shape of the gesture complies with the preset shape according to the information included in the sensing signal in the embodiment. That is, it determines whether the shape of the gesture complies with the preset shape for performing the preset function in the second control mode. Therefore, the control unit 22 controls the touch control module 18 to enter the first control mode, thereby allowing the user to perform the preset function via the touch control module 18.

When the touch control module 18 enters the first control mode, the user cannot control the cursor displayed on the display 10 via the touch control module 18. At that moment, the touch control module 18 first generates a first touch signal according to the contact of the user's finger. Then, the control unit 22 generates a first input trace according to the first touch signal, and afterwards the electronic device 1 performs the corresponding preset function according to the first input trace.

In the embodiment, the preset function is adjusting or setting a software function, such as the sound or video effect or a hardware function of the electronic device 1. For example, adjusting the sound effect of the electronic device 1 may be the volume adjustment, the mute, the sound field adjustment and the track adjustment. Adjusting the video effect of the electronic device 1 may be the luminance adjustment, the color saturation adjustment, the color temperature adjustment, the display rotation adjustment, closing the display, etc. Furthermore, adjusting the sound effect or video effect of the electronic device 1 also includes adjusting the image browse function and the display functions of music and video, which may be play, pause, fast forward and fast rewind the music or the movie, switch to the former image, switch to next image, zoom out, or zoom in the image.

In other embodiments, to perform the preset function, the functional menu of the electronic device 1 is first displayed on the display 10, and the functional menu includes multiple functional options such as play, pause, playing the former song, playing the next song, increasing volume, decreasing volume, and it is not limited thereto. The functional option also may include the above preset functions. Followed with the operating of the touch control module 18 by users, the second touch signal continued to generate. Then, after the control unit 22 receives the second touch signal, the second input trace generates according to the second touch signal, thereby making the electronic device 1 perform the functional option in the functional menu according to the second input trace.

For example, when the thumb of the user's right hand draws a sector, the touch control module 18 may generate a first touch signal, and the control unit 22 generates the sector trace according to the first touch signal. Then, the electronic device displays the functional menu on the display 10 according to the sector trace.

Then, if the thumb of the user's right hand moves up and down or draws a circle, as shown in FIG. 6B and FIG. 6C, the touch control module 18 generates the second touch signal, and the control unit 22 generates the second input trace according to the second touch signal. According to different kinds of second input traces, the electronic device 1 then performs corresponding functional options in the functional menu. For example, the user may move up and down to switch the functional options in the functional menu and draw a circle to perform the functional option in the functional menu. If the user draws a circle by the thumb of the left hand, the touch control module 18 generates the second touch signal, and the control unit 22 generates a second input trace according to the second touch signal. The electronic device 1 may close the functional menu and not show the cursor of the functional menu on the display 10 according to the second input trace. The second input trace may be drawing a sector trace downwardly by the left hand.

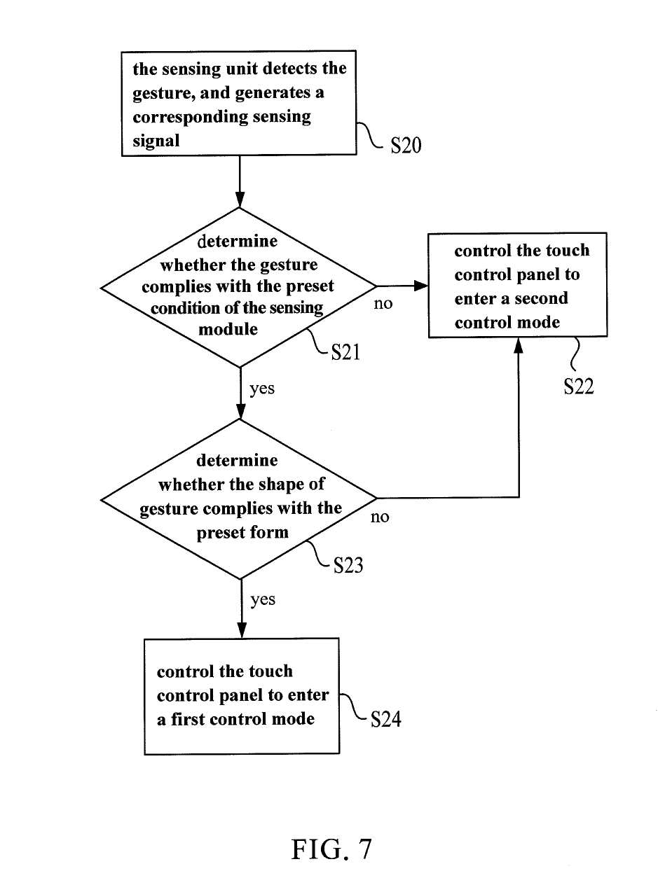

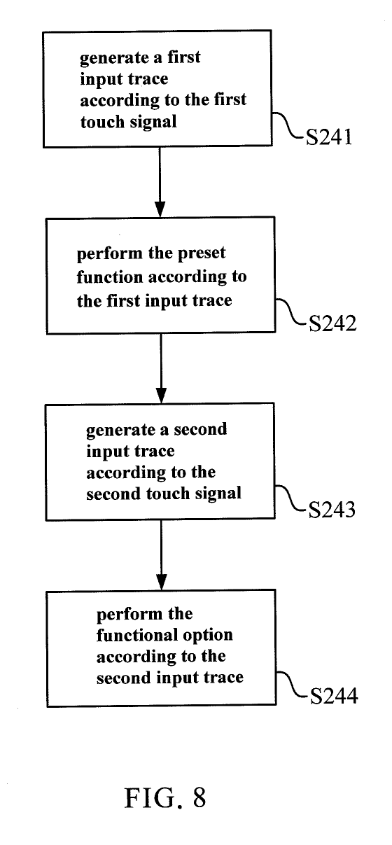

FIG. 7 is a flow chart diagram showing the method for controlling the touch control module in an embodiment. FIG. 8 is a flow chart showing the method that the control unit controls the touch control module to enter a first control mode in an embodiment. The method may be adapted to the electronic device as described above, and in the following part, the electronic device 1 is taken as an example to illustrate the flow chart.

As shown in FIG. 7, the invention includes the steps as follows. Firstly, the sensing module 20 detects the gesture when the user's hand is disposed on the palm rest board 16, and then generates the corresponding sensing signal (step S20). Then, the control unit 22 determines whether the gesture complies with a preset condition according to the sensing signal (step S21). If the determining result is no, the touch control module enters a second control mode (step S22) to allow the user to control the cursor displayed on the display 10 via the touch control module.

In an embodiment, if the control unit 22 determines that the gesture complies with the preset condition according to the sensing signal, the control unit 22 further determines whether the shape of the gesture complies with the preset shape according to the sensing signal (step S23). If the determining result is no, the touch control module 18 enters the second control mode (step S22). If the determining result is yes, the touch control module 18 enters the first control mode (step S24).

In other embodiments, if the control unit 22 determines that the gesture complies with the preset condition according to the sensing signal, the touch control module will be controlled directly to enter the first control mode (step S24) for the users to control the electronic device 1 to perform the preset function via the touch control module 18.

Then, as shown in FIG. 8, when the touch control module 18 enters the first control mode, the user cannot control the cursor displayed on the display 10 via the touch control module 18. At that moment, the touch control module 18 may generate the first touch signal to the control unit 22 according to the contact of the finger on the touch control module 18. At the same time, the control unit 22 generates the first input trace according to the first touch signal (step S241).

Then, the electronic device 1 performs the corresponding preset function according to the first input trace (step S242). In the embodiment, the electronic device 1 performs the multi-media functions or adjusts the system functions according to the first input trace. For example, the functions may include starting to play video or music, pause, fast playing, back or adjusting the volume of the loud speaker 24, adjusting the luminance of the display 10 and so on, but it is not limited herein.

In other embodiments, the electronic device 1 displays the functional menu on the display 10 according to the first input trace. At that moment, the touch control module 18 generates the second touch signal and transmits the second touch signal to the control unit 22 according to the contact of the user's finger on the touch control module 18. The control unit 22 generates the second input trace according to the second touch signal (step S243). At last, the electronic device 1 performs the functional option in the functional menu according to the second input trace (step S244).

To sum up, in the method for controlling the touch control module and the electronic device, the touch control module includes multiple control modes, and it may control the cursor or perform the preset function. Besides, in the touch control module and the electronic device of the invention, the control modes of the touch control module may be switched according to the gesture when the user's palm is disposed on the palm rest board; thereby the user uses the touch control module more conveniently.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method for controlling a touch control module of an electronic device, wherein the electronic device has a display and a sensing module, and the sensing module has a sensing unit, the method comprising the steps of:
detecting a gesture by the sensing unit and generating a corresponding sensing signal;
determining whether the gesture complies with a preset condition according to the sensing signal; and
controlling the touch control module to enter a first control mode if the gesture complies with the preset condition, and controlling the touch control module to enter a second control mode if the gesture is not complies with the preset condition.

2. The method according to claim 1, wherein the first control mode is used to control the electronic device to perform a preset function via the touch control module.

3. The method according to claim 1, wherein the second control mode is used to control a cursor displayed on the display via the touch control module.

4. The method according to claim 1, further comprising the steps of:
determining whether a shape of the gesture complies with a preset shape according to the sensing signal if the gesture complies with the preset condition;
controlling the touch control module to enter the first control mode if the shape of the gesture complies with the preset shape; and
controlling the touch control module to enter the second control mode if the shape of the gesture does not comply with the preset shape.

5. The method according to claim 2, further comprising the steps of:
generating a first input trace according to a first touch signal if the gesture complies with the preset condition; and
performing the corresponding preset function according to the first input trace.

6. The method according to claim 1, wherein the gesture is a finger gesture, a palm gesture or their combination.

7. The method according to claim 5, wherein the preset function is displaying a functional menu on the display, the method further comprising the steps of:
generating a second input trace according to a second touch signal; and
performing a functional option in the functional menu according to the second input trace.

8. The method according to claim 2, wherein the preset function is adjusting or setting a software function or a hardware function of the electronic device.

9. The method according to claim 1, wherein the cursor displayed on the display is incapable of being controlled via the touch control module when the touch control module enters the first control mode.

10. An electronic device comprising:
a display; and
a host connected to the display, the host including:
a sensing module has at least a sensing unit used for detecting a gesture and generating a corresponding sensing signal,
a touch control module, and
a control unit electrically connected to the touch control module and the sensing module,
wherein the control unit determines whether the gesture complies with a preset condition according to the sensing signal, if gesture complies with the preset condition, the control unit controls the touch control module to enter a first control mode, and if the gesture does not comply with the preset condition, the control unit controls the touch control module to enter a second control mode.

11. The electronic device according to claim 10, wherein the first control mode is used to control the electronic device to perform a preset function via the touch control module.

12. The electronic device according to claim 10, wherein the second control mode is used to control a cursor displayed on the display via the touch control module.

13. The electronic device according to claim 10, wherein if the control unit determines that the gesture complies with the preset condition, the control unit further determines whether a shape of the gesture complies with a preset shape according to the sensing signal, if it determines that the shape of the gesture complies with a preset shape, the control unit controls the touch control module to enter the first control mode, and if it determines that the shape of the gesture does not comply with the preset shape, the control unit controls the touch control module to enter the second control mode.

14. The electronic device according to claim 11, wherein when the touch control module enters the first control mode, the touch control module generates a first input trace according to a first touch signal, and the electronic device performs the corresponding preset function according to the first input trace.

15. The electronic device according to claim 10, wherein the hand gesture is a finger gesture, a palm gesture or their combination.

16. The electronic device according to claim 14, wherein the preset function is displaying a functional menu on the display by the electronic device, and generating a second input trace according to a second touch signal by the touch control module, thereby making the electronic device perform a functional option in the functional menu according to the second input trace.

17. The electronic device according to claim 10, wherein the preset function is adjusting or setting a software function or a hardware function of the electronic device.

18. The electronic device according to claim 10, wherein when the touch control module enters the first control mode, the cursor on the display is incapable of being controlled via the touch control module.

19. The electronic device according to claim 10, wherein the sensing module comprises multiple sensing units disposed near the touch control modules to detect the gestures on left palm and right palm.

20. The electronic device according to claim 10, wherein the sensing unit comprises one of a capacitance sensor, a proximity sensor and a luminance sensor.
